(19) United States
(12) Patent Application Publication
(10) Pub. No.: US 2004/0050557 A1
(43) Pub. Date: Mar. 18, 2004

(54) Fire engine trailer

(76) Inventor: Alfons Koopmann, Friesoythe-Markhausen (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/363,236

(22) PCT Filed: Sep. 4, 2001
(86) PCT No.: PCT/EP01/10138

(30) Foreign Application Priority Data
Sep. 7, 2000 (DE) 100 44 094.0

(51) Int. Cl. A62C 27/00

(52) U.S. Cl. 169/24; 169/52; 239/172

(57) ABSTRACT

The invention concerns a trailer which can be pulled by a conventional towing unit, e.g., a tractor, in particular with reference to its safe use at the scene of a fire, and also concerns improved use of the fire-fighting trailer.

To solve the problem, the invention essentially proposes to provide a protection device, which effectively protects the personnel operating the fire-fighting trailer and also guarantees the possibility of rescuing persons from the scene of a fire.

Fire-fighting trailer with a personnel protection device that essentially consists of two containers, of which one is provided to hold a fire-extinguishing and/or cooling agent, preferably water; in addition, water discharge devices, preferably spraying devices, are provided on the trailer, through which the extinguishing/cooling agent can be discharged from the tank, so that the trailer is constantly sprayed with the extinguishing/cooling agent at least in the areas in which personnel are present.

The invention concerns a trailer which can be pulled by a conventional towing unit, e.g., a tractor.

Such a trailer is already known from DE 297 17 855.5.

The present invention concerns an improvement to the aforementioned trailer, particularly with regard to its safe use at the scene of a fire. The invention also concerns the improved use of the fire-fighting trailer.

The invention is realized according to a fire-fighting trailer with the features from claim 1. Advantageous refinements are described in the subordinate claims.

The solution essentially proposed by the invention is to provide a protection device which effectively protects the personnel operating the fire-fighting trailer and which also guarantees the possibility of rescuing persons from the scene of a fire.

To reliably guarantee personnel protection, the fire-fighting trailer has a tank, which essentially consists of two parts, wherein the contents of one part of the tank are always maintained for reliable personnel protection and are not inadvertently emptied for fire fighting.

Personnel protection can be realized by providing several water nozzles or spraying devices, which are connected to the water tank, on the entire trailer. If water is discharged through these spraying devices, this is done less for fire fighting than for personnel protection. Here, the entire fire-fighting trailer (and possible towing unit) and the personnel located on the trailer are sprayed with water, so that a very large cooling effect is realized, and so that the trailer, as well as the personnel on the trailer, do not suffer injuries or damage due to heat.

If the trailer is moved during operation of the personnel protection function, then a type of water tunnel is formed practically around the trailer, which also allows more persons than just the operating personnel to be rescued from the scene of a fire.

However, the personnel protection also guarantees that the fire-fighting trailer stores a separate drinking water tank, so that persons, who may possibly be surrounded along with the trailer, will always have sufficient drinking water at the scene of a fire.

Level regulation of the entire trailer is also used for personnel protection. If the trailer is resting, e.g., at a slight incline, working on the trailer is often not easy because it is at an angle. This situation can easily lead to accidents due to operating personnel slipping on the trailer, and, under some circumstances, the entire trailer cannot be used optimally because, e.g., the tank still holds water which cannot be used because the trailer, and thus also the tank, is inclined.

As an aid, the trailer has self-activating level regulation, e.g., hydraulic level regulation, by means of which the entire trailer can be brought to a horizontal position, so that safe operation of the fire-fighting trailer is possible.

The fire-fighting trailer is also preferably equipped with its own stationary motor and/or a compressor with gripper control connected to the motor, so that these devices can also provide the necessary operating pressure, e.g., at the level of 35 bar, for the discharge of water through high-pressure discharge devices or also the refueling of the entire trailer independently of the towing vehicle (and its power-take-off drive). The gripper control acts so that when a certain operating pressure, e.g., 35 bar, is achieved, the compressor is not completely turned off, but instead continues in a quasi “free-running” state and thus the establishment of pressure can be generated as soon as the pressure is needed without turning on the compressor.

For fire fighting itself, the fire-fighting trailer has a plurality of fire-fighting devices or a water gun, by means of which 1600 liters of water per minute can be discharged. In addition, various attachments for particular kinds of fire-fighting devices and other known fire-fighting nozzles are also provided.

For fire-fighting devices, which atomize and explosively discharge the fluid, it is possible for the discharge point to be formed not only in the form of a beam, but also in very wide shapes, or also to deflect the entire discharge onto very large surfaces, which support the cooling effect and thus the fire-fighting effect. It is particularly advantageous if it is possible to adjust the discharge profile from a point stream into a large area discharge during operation, which is possible by means of a corresponding discharge nozzle on the outlet of the fire-fighting device, if the discharge profile of the nozzle can be adjusted.

The fire-fighting equipment according to the invention also includes an oil cooling device, which can cool all of the oil required for the operation of the fire-fighting device. This is very advantageous, particularly for drives, because these drives often turn themselves off due to overheating, which can have catastrophic effects in an emergency if there is no cooling capability for the operating oil.

Especially effective for use in forest fires, brush fires, or marshland fires is also an extinguishing lance, which is connected to the tank by means of a water hose with a corresponding attachment. This extinguishing lance, which essentially consists of a tube, e.g., of 1-5 m length, with opening(s) at one end, can be used to fight the source of a fire which is not easily accessible from the outside. This is particularly true for marshland fires, where extinguishing the fire at the surface can rarely effectively fight the meter-deep sources of the fire.

In addition, the fire-fighting trailer according to the invention is also provided with an adapter for a foam gun, so that a large foam blanket can also be laid over the water with a foam reservoir.

For vehicle safety, the fire-fighting trailer according to the invention is also provided with tire protection which, like the personnel protection, is formed by water nozzles which spray a fine jet of water onto the tires, so that the tires cannot suffer fire damage. Because the drivability of the entire trailer essentially depends on the tires and their functionality, an automatic tire pressure monitor is provided, and if air is lost all at once, the tire pressure can be refilled by a corresponding compressor, which is provided on the fire-fighting trailer according to the invention.

The compressor is preferably driven hydraulically, e.g., also by means of the power-takeoff drive of the towing unit, and a high operating pressure, e.g., at the level of 35 bar, can be made available by this compressor.

On the tank or on the two parts of the tank, a viewing tube is provided so that the remaining water level in the tank can be read at any time with a simple means and method without complications.

For additional operating protection of the fire-fighting trailer, the trailer is also equipped with a tree saw and/or motor saw, so that if trees or large branches block the path of motion, they can be removed quickly.

All equipment of the fire-fighting trailer according to the invention is tightly or loosely mounted on the trailer so that it can be removed or it is attached so that it can be made ready for use without a problem within a very short time.

The trailer according to the invention can also be set (used) for tunnel fires, or else for fighting large plagues of insects, e.g., plagues of locusts. For this case, even in rural areas, where extensive use of insecticides is otherwise rarely performed, the tank can be filled with insecticides or other chemical materials, such as herbicides, fungicides, and the like, instead of water, and these materials can then be discharged through the various fire-fighting devices. It is known that this is particularly effective by means of the 15-liter Intruder cannon. Thus, the infestation of other diseases, plants, viruses, etc., can also be fought effectively with the firefighting trailer according to the invention, particularly if the fire-fighting trailer can travel anywhere within the rural areas.

For reliable upright positioning, the fire-fighting trailer is built as a two-axle vehicle, so that the fire-fighting trailer can still travel even if one tire is lost completely.

Parts of the fire-fighting devices can also be mounted on carriers which can be moved hydraulically. Thus, the entire fire-fighting trailer is always compact and the corresponding firefighting trailer can be moved while in use, which is particularly advantageous when the devices can no longer be held just by the personnel, which is the case, e.g., for the Intruder cannon.

The described fire-fighting trailer of the invention has been successfully tested in unpublished tests and these tests have shown that the effectiveness, not only of the extinguishing device, but also of personnel protection, is unmatched relative to prior fire-fighting devices and trailers.

All of the parts of the fire-fighting devices according to the invention are heat-resistant as much as possible, i.e., their functional ability is guaranteed even at high temperatures, that is, over 60° [C.].

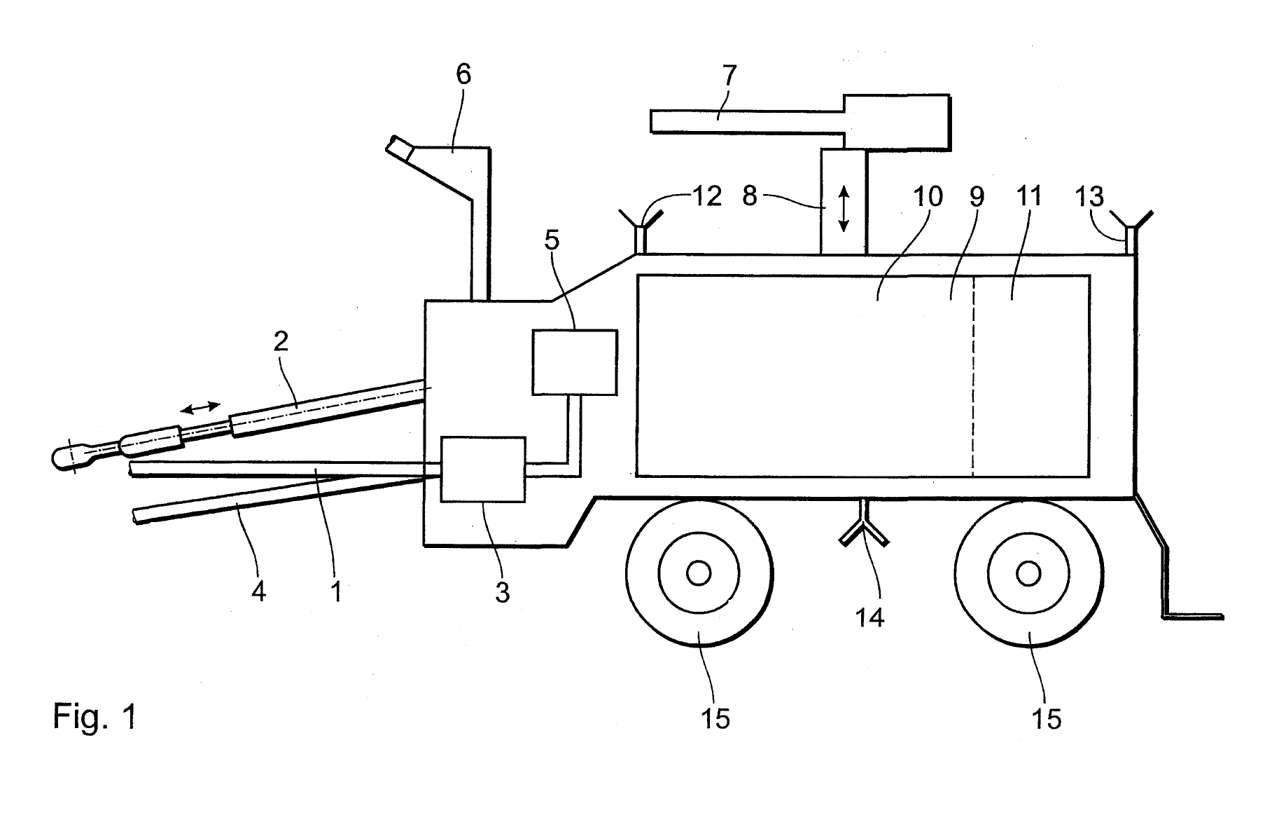

FIG. 1 shows the principle design of a fire-fighting trailer of the invention, which can be pulled by a towing unit, e.g., by a tractor. By means of a hydraulic rail hinged to the trailer axle 1, the entire trailer can be adjusted by adjusting the other hydraulic rail of the trailer, so that even on uneven terrain the trailer is still essentially horizontal and thus can also be operated by operating personnel.

The trailer has its own stationary motor 3, which is either self-driven or driven by the power-take-off shaft 4, which can be connected to the power-take-off drive of the towing unit. The stationary motor is in turn connected to a compressor 5, which has on its side a gripper control, by means of which the operating pressure is made available for various system parts of the trailer.

In the illustrated example, the trailer has, e.g., a water gun 6 and an explosive firefighting discharge device 7. The explosive fire-fighting discharge device 7 can be adjusted in elevation, which can be realized by a cylinder 8 that can be adjusted in elevation and that is controlled hydraulically.

The fire-fighting trailer has an essentially two-part tank 9, whose first part 10 essentially holds the water or the fire-extinguishing agent or fluid for fire fighting, and whose second part 11 holds the fluid which is stored for self-protection of the trailer. For self-protection of the trailer, various spraying devices 12, 13, 14 are provided. If the trailer comes too close to the source of a fire, by triggering the personnel protection or self-protection, the spraying of water through the spraying devices can be triggered so that the entire trailer is immersed in a type of water tunnel, wherein the water tunnel essentially consists of sprayed water. This has the effect of considerably cooling the entire trailer and also the operating personnel on the trailer.

Especially those spraying devices that are directed onto the tires of the trailer will have the effect of particularly protecting the tires so that they are not burnt or scorched when passing over a burning area.

The fire-fighting trailer according to the invention can be provided with an additional number of fire-fighting devices, e.g., an extinguishing lance, additional fire-fighting devices, e.g., also a foam gun.

All of the attachments are made available directly on the fire-fighting trailer, which guarantees outstanding flexibility of the fire-fighting trailer during use.

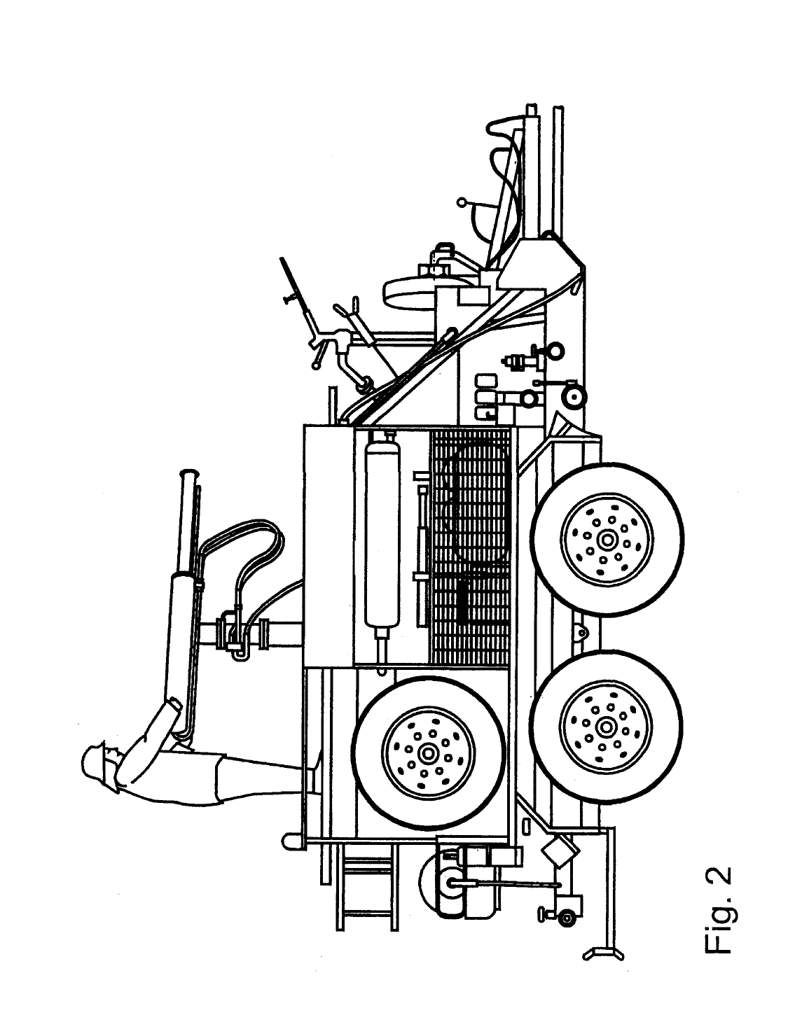

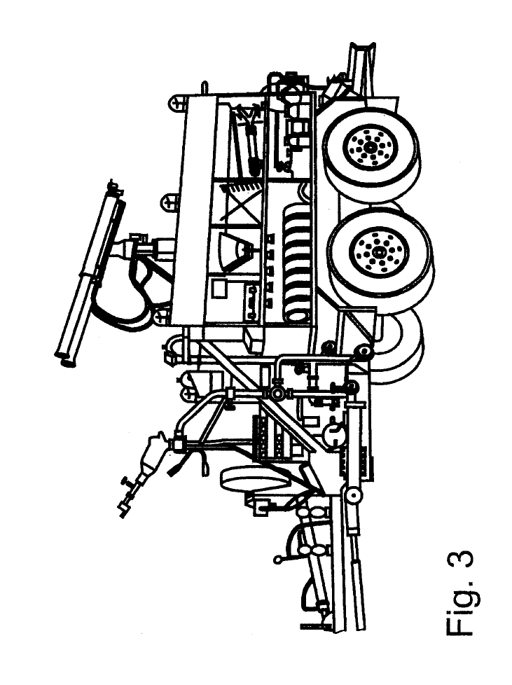

Additional details of the fire-fighting devices according to the invention are also shown in the enclosed drawings according to FIGS. 3 and 4.

The effectiveness of the fire-fighting equipment of the invention can be increased still more if water from the fire-fighting tank and high-pressure air are mixed by means of a high-pressure device (compressor), e.g., at a high pressure of 8 bar, in a turbulence channel, and this mixture is then fed to a mixer, where the water-air mixture (under high pressure) is mixed with a foaming agent, wherein the amount of foaming agent is in the range of 0.2% to 5%, preferably 0.4% of the total mixture mass.

In this way, the extinguishing amount of, e.g., 6000 L of water in the tank can be increased to 72,000 L of wet foam or 120,000 L dry foam, which can be sprayed with the discharge devices of the fire-fighting trailer to a distance of more than 20 m, preferably 30 m to 50 m.

1. Fire-fighting trailer with a personnel protection device essentially consisting of two containers, of which one container is provided to hold a fire-extinguishing and/or cooling agent, preferably water; in addition, water discharge devices, preferably spraying devices, are provided, through which the extinguishing/cooling agent can be discharged from the tank, so that the trailer is constantly sprayed with the extinguishing/cooling agent at least in the area in which personnel are present.

2. Trailer according to claim 1, characterized in that extinguishing agent discharge devices are provided, by means of which the wheels or tires of the trailer are sprayed.

3. Trailer according to one of the preceding claims, characterized in that water or extinguishing agent is sprayed in the direction of the towing unit of the trailer, so that the towing unit is also protected against direct attack by fire.

4. Trailer according to one of the preceding claims, characterized in that the first and second tank are formed by a common tank arrangement consisting of two different chambers.

5. Trailer according to one of the preceding claims, characterized in that the trailer has an active level regulation device, by means of which the trailer can be adjusted so that the working platform of the trailer is essentially level.

6. Trailer according to one of the preceding claims, characterized in that the trailer has a stationary motor, by means of which all of the systems and apparatus of the trailer can be driven and/or supplied with power and/or operating pressure.

7. Trailer according to one of the preceding claims, characterized in that an attachment on the trailer is provided for an extinguishing lance, which essentially consists of a tube.

8. Trailer according to one of the preceding claims, characterized in that an attachment on the trailer is provided for a foam gun, by means of which a large foam blanket can be laid when it is activated.

9. Trailer according to one of the preceding claims, characterized in that the tires are especially heat-resistant or fireproof.

10. Trailer according to one of the preceding claims, characterized in that an attachment for a tree saw or motor saw is provided.

11. Trailer according to one of the preceding claims, characterized in that a device is provided which can cool the oil required by various trailer parts.

12. Trailer according to one of the preceding claims, characterized in that the trailer has a compressor with gripper control, by means of which an operating pressure of 35 bar can be made available to operate various fire-fighting devices.
